(19) United States
(12) Patent Application Publication
(10) Pub. No.: US 2026/0032207 A1
(43) Pub. Date: Jan. 29, 2026

(54) IMAGE FORMING APPARATUS, CONTROL METHOD OF IMAGE FORMING APPARATUS, AND STORAGE MEDIUM

(71) Applicant: CANON KABUSHIKI KAISHA, Tokyo (JP)

(72) Inventor: KENTA USAMI, Chiba (JP)

(21) Appl. No.: 19/277,517

(22) Filed: Jul. 23, 2025

(30) Foreign Application Priority Data
Jul. 26, 2024 (JP) 2024-121444

(51) Int. Cl. H04N 1/00

(52) U.S. Cl. CPC H04N 1/00899; H04N 1/00896; H04N 2201/0094

(57) ABSTRACT

Irrespective of whether or not an image forming apparatus is equipped with a power measurement instrument, an environmentally friendly way of using the image forming apparatus can be presented. In a case where an image forming apparatus includes a measuring unit configured to measure an amount of power consumption of the printing unit, the image forming apparatus displays an amount of power consumption for a certain period on a display unit based on a measurement result for the certain period by the measuring unit. On the other hand, in a case where the image forming apparatus does not include the measuring unit, the image forming apparatus displays a percentage of each of a plurality of power statuses in the image forming apparatus for the certain period on the display unit.

### BACKGROUND

### Field of the Technology

The present disclosure relates to a method of presenting an environmentally friendly way to use an image forming apparatus.

### Description of the Related Art

In recent years, environmental issues have become global issues to be tackled, and all the countries and companies have been being required to take measures for the environmental issues. One of the measures for the environmental issues in image forming apparatuses is to reduce power consumption. For reducing power consumption, there are methods such as a power saving method through technological improvement and in addition a method of encouraging users to be environmentally conscious, thereby leading to a reduction in power consumption. As the latter method, it is already known to calculate and display an actual amount of power consumption in an image forming apparatus. For example, Japanese Patent Laid-Open No. 2011-85796 proposes a method in which an image forming apparatus is equipped with an instrument to measure an amount of power consumption and an amount of power consumption in each operation mode is actually measured, so that the amount of power consumption with high accuracy is calculated and displayed.

### SUMMARY

A storage medium according to the present disclosure is a non-transitory computer readable storage medium storing a program for causing a computer to perform a control method of an image forming apparatus including a printing unit, the method comprising the steps of: in a case where the image forming apparatus includes a measuring unit configured to measure an amount of power consumption of the printing unit, causing the image forming apparatus to execute a first process of displaying an amount of power consumption for a certain period based on a measurement result for the certain period by the measuring unit on a display unit; and in a case where the image forming apparatus does not include the measuring unit, causing the image forming apparatus to execute a second process of displaying a percentage of each of a plurality of power statuses in the image forming apparatus for the certain period on the display unit.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating an example of a configuration of an image forming system;

FIG. 2A is a block diagram illustrating an internal configuration of a controller and FIG. 2B is a block diagram illustrating an internal configuration of a printer mechanism;

FIG. 3 is a plan view for explaining a configuration of an operation unit;

FIG. 4 is a diagram for explaining transitions between multiple power statuses;

FIG. 5 is a flowchart presenting a flow of processes for accumulating power-related information;

FIGS. 6A and 6B are diagrams presenting power-related information in a table format;

FIG. 7 is a flowchart presenting a flow of processes for presenting power-related information;

FIG. 8 is a diagram illustrating a UI screen showing a transition of an amount of power consumption; and

FIG. 9 is a diagram illustrating a UI screen showing the percentages of power statuses.

### DESCRIPTION OF THE EMBODIMENTS

Regarding image forming apparatuses, their product lineup varies from high-performance, high-priced models to low-priced models with fewer functions. Depending on product specifications, some products can be equipped with power measurement instruments, but other some products cannot. For this reason, it may happen that the aforementioned technique in Japanese Patent Laid-Open No. 2011-85796 to calculate and display the amount of power consumption with high accuracy can be applied to high-end products equipped with power measurement instruments, but cannot be applied to low-end products not equipped with power measurement instruments.

According to the technique disclosed herein, it is possible to present an environmentally friendly way of using an image forming apparatus irrespective of whether or not the image forming apparatus is equipped with a power measurement instrument.

Hereinafter, with reference to the attached drawings, the present disclosure is explained in detail in accordance with preferred embodiments. Configurations shown in the following embodiments are merely and the present disclosure is not limited to the configurations shown schematically.

### First Embodiment

### <System Configuration>

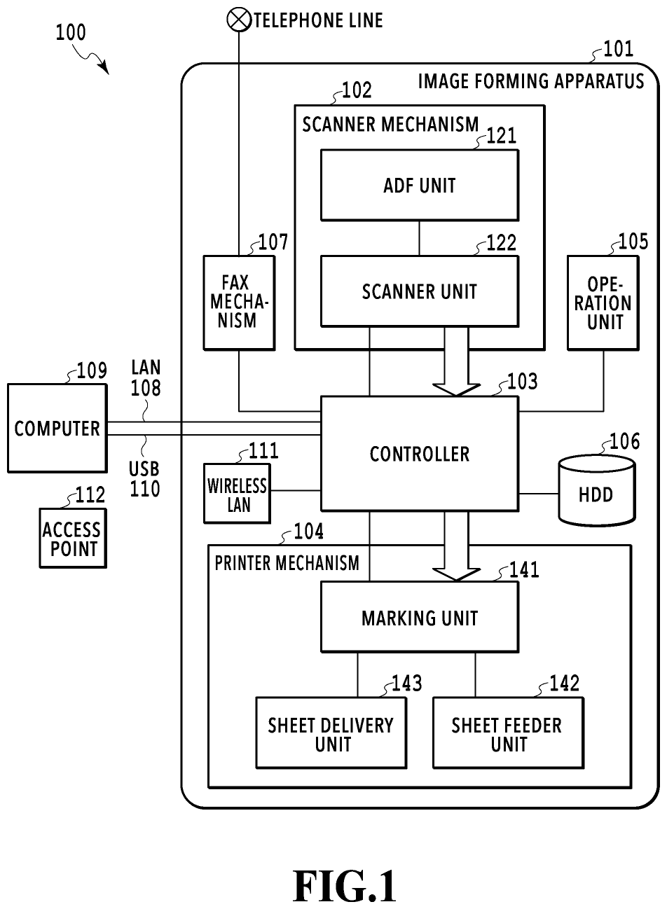

FIG. 1 is a block diagram illustrating an example of an image forming system according to the present embodiment. An information processing system 100 in the present embodiment includes an image forming apparatus 101, a computer (information processing apparatus) 109, and an access point 112.

The image forming apparatus 101 is a so-called multi-function machine having multiple functions such as a copy function, a print function, a data transmission function, and a data storage function. The image forming apparatus 101 is configured to be capable of receiving print instruction data (called “a print job”) from the computer 109 via a LAN 108. Here, two or more computers 109 may be connected to the image forming apparatus 101. A scanner mechanism 102 optically reads a document and converts the document into a digital image. A printer mechanism 104 forms a digital image on a print medium such as a paper or plastic sheet (hereinafter referred to as “a sheet”). An operation unit 105 includes a touch panel and hardware keys for receiving various settings for the image forming apparatus 101 from a user and displaying a processing status. An HDD 106 is a large capacity non-volatile storage device that stores data of digital images, control programs, and so on. An SSD or eMMC may be used in place of the HDD 106. A FAX mechanism 107 transmits and receives data of digital images to and from a telephone line or the like. A controller 103 is connected to the scanner mechanism 102, the printer mechanism 104, the operation unit 105, the HDD 106, and the FAX mechanism 107, and executes jobs of the functions on the image forming apparatus 101 by issuing an instruction to each module. The image forming apparatus 101 is capable of inputting and outputting events and data from and to the computer 109 via the access point 112 and a wireless LAN 111, Moreover, the image forming apparatus 101 is capable of inputting and outputting events and data from and to the computer 109 via a USB 110.

The scanner mechanism 102 includes an ADF unit 121 capable of feeding documents one by one from a batch of documents placed therein, and a scanner unit 122 configured to optically read the documents and converts them into digital images. The data of the digital images obtained by the conversion is transmitted to the controller 103.

The printer mechanism 104 feeds sheets one by one from a batch of sheets placed in a sheet feeder unit 142, prints a digital image on a sheet in a marking unit 141, and outputs the printed sheet from a sheet delivery unit 143. The printer mechanism 104 will be described in detail later. In the present embodiment, the printing method is assumed to be an electrophotographic method, but any other printing method such as an inkjet method may also be used.

The configuration of the image forming system illustrated in FIG. 1 is just an example, and the system configuration is not limited to this. For example, the system may further include a finisher mechanism configured to perform processes, such as sorting, stapling, punching, and cutting, on printed sheets outputted from the printer mechanism 104. The image forming apparatus 101 may also be a single function printer specialized only for the print function.

### <Outline of Functions of Image Forming Apparatus>

The outline of the functions equipped in the image forming apparatus 101 in the present embodiment is as follows.

### <<Copy Function>>

This is a function to obtain image data with the scanner unit 122 by reading a document set in the ADF unit 121 and print the image data on a sheet with the printer mechanism 104.

### <<Print Function>>

This is a function to print image data on a sheet with the printer mechanism 104, the image data being image data contained in a print job transmitted from the computer 109, image data stored in advance in the HDD 106 (Box storage), or the like.

### <<Data Transmission Function>>

This is a function to transmit image data, which is obtained by reading a document with the scanner mechanism 102, to an external apparatus such as the computer 109 via the LAN 108.

### <<Data Storage (Box Storage) Function>>

This is a function to store image data, which is obtained by reading a document with the scanner mechanism 102, in the HDD 106, so that the stored image data can be printed or transmitted to an external apparatus as needed.

### <Internal Configuration of Controller>

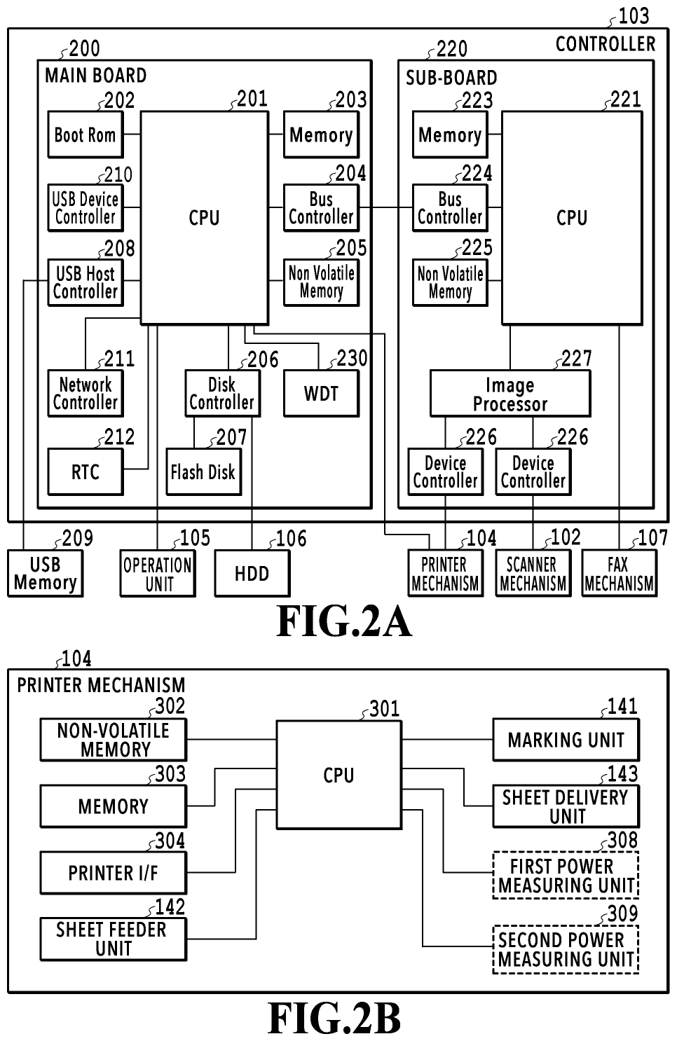

Next, an internal configuration of the controller 103 is described by using a block diagram illustrated in FIG. 2A. The controller 103 includes a main board 200 and a sub-board 220. The main board 200 is a so-called general-purpose CPU system. The main board 200 includes a CPU 201 to control the image forming apparatus 101 overall, a boot ROM 202 to store a boot program, a memory 203 to be used as a work memory by the CPU 201, and a bus controller 204 having a bridge function with an external bus. The main board 200 also includes a non-volatile memory 205 to keep data from being erased even if the power is cut off, a disk controller 206 to control a storage device, a flash disk 207 such as an SSD or eMMC, and a USB host controller 208 to control the USB. The main board 200 further includes a USB device controller 210 to transmit and receive data or the like from the computer 109 via the USB 110, and a network controller 211 to transmit and receive data or the like from the computer 109 via the access point 112. This network controller 211 serves as the above wireless LAN 111 in FIG. 1. The CPU 201 controls a watchdog timer (WDT) 230 to reset the controller 103, and controls the network controller 211 for transmitting and receiving data to and from the computer 109 via the LAN 108. The CPU 201 also controls a RTC 212 for setting a current time or a return time. A USB memory 209, the operation unit 105, the HDD 106, and so on are connected to the main board 200.

The sub-board 220 includes a relatively-small general-purpose CPU system and image processing hardware. The sub-board 220 includes a CPU 221 to control the sub-board 220 overall, a memory 223 to be used as a work memory by the CPU 221, a bus controller 224 having a bridge function with an external bus, a non-volatile memory 225, an image processor 227, and device controllers 226. The printer mechanism 104 receives the data of digital images from the scanner mechanism 102 via the device controllers 226. The sheet on which a print process is performed by the printer mechanism 104 is outputted to a sheet receiving tray (not illustrated). The CPU 221 controls the FAX mechanism 107. Here, FIG. 2 is the block diagram illustrating main constituent elements of the controller and some constituent elements are simplified. For example, the CPU 201, the CPU 221, and so on each include peripheral hardware of the CPU such as a chip set, a bus bridge, and a clock generator, which are omitted. The configuration of the controller 103 illustrated in FIG. 2 is just an example, and the configuration is not limited to the above configuration.

### <Operations of Controller>

Next, operations of the controller 103 are described by using, as an example, a case of executing the copy function. In response to a user's copy instruction from the operation unit 105, the CPU 201 transmits a command to read a document to the scanner mechanism 102 via the CPU 221. The scanner mechanism 102 optically reads the document, generates image data in a digital format in which each pixel has a RGB color value, and inputs the image data to the image processor 227 via the device controller 226. The image processor 227 performs direct memory access (DMA) transfer of the image data to the memory 223 via the CPU 221, thereby temporarily storing the image data in the memory 223. Next, upon confirmation that a certain amount or all of the image data is stored in the memory 223, the CPU 201 issues an instruction to output the image data to the printer mechanism 104 via the CPU 221. The CPU 221, which receives the output instruction, notifies the image processor 227 of a storage location address of the image data in the memory 223. The image data in the memory 223 is transmitted to the printer mechanism 104 via the image processor 227 and the device controller 226 in accordance with a synchronization signal from the printer mechanism 104. Then, the printer mechanism 104 prints the image data on a sheet. In a case where multiple copies are to be printed, the CPU 201 stores, in the HDD 106, the image data in the memory 223. For printing the second and following copies, the image data does not have to be received from the scanner mechanism 102, but can be transmitted from the HDD 106 or the memory 223 to the printer mechanism 104.

### <Internal Configuration of Pinter Mechanism>

FIG. 2B is a block diagram illustrating an internal configuration of the printer mechanism 104. Hereinafter, the printer mechanism 104 is described in detail by using FIG. 2B.

A CPU 301 is an arithmetic processing device to control the printer mechanism 104. A non-volatile memory 302 is a memory device such as a ROM that stores programs to be executed by the CPU 301. A memory 303 is a memory device such a DRAM into which the CPU 301 temporarily stores data. A printer I/F 304 is an interface for connection with the controller 103. The marking unit 141 performs a process of printing image data, received from the controller 103 via the printer I/F 304, on a sheet fed by the sheet feeder unit 142. The sheet printed by the marking unit 141 is outputted by the sheet delivery unit 143. The printer mechanism 104 includes two measurement instruments (power measuring units) for measuring the actual amounts of power consumption. One of them is a first power measuring unit 308 to record a cumulative amount of power consumption for operations, such as sheet feeding, delivery, and conveyance, other than a fixing process to be described later. The other is a second power measuring unit 309 to record a cumulative amount of power consumption required for the fixing process of fixing images (toner images in the case of an electrophotographic system) formed on sheets with heat and pressure. Each of these power measuring units has a function to record the cumulative amount of power consumption up to an upper limit value, and is capable of obtaining an amount of power consumption for a certain target period from a difference value between the value of the cumulative amount of power consumption at a certain past time point and the value of the cumulative amount of power consumption at the current time point. The total value of the amounts of power consumption for a certain period obtained based on the measured values of the first power measuring unit 308 and the second power measuring unit 309 is the value of the total amount of power consumption for the certain period of the printer mechanism 104. The power measuring units 308 and 309 are not essential constituent elements of the printer mechanism 104, and may be included optionally depending on product specifications.

### <Configuration of Operation Unit>

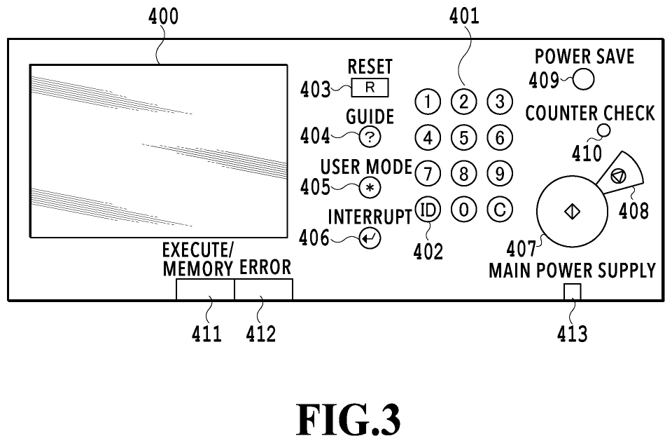

FIG. 3 is a plan view for explaining a configuration of the operation unit 105 of the image forming apparatus 101. The operation unit 105 includes a touch panel 400, various keys 401 to 410, and various LEDs 411 to 413. The touch panel 400 is a display device such as an LCD integrated with an input device, which displays various user interface screens (UI screens) for a selection of a function to be used, print settings for printing, and so on. A user can perform various operations by directly touching the surface of each UI screen. Ten keys 401 are keys for inputting numeric values of 0 to 9, an ID key 402 is a key for inputting a division number or the like in a case where the apparatus is managed on a division basis, a reset key 403 is a key for resetting the set mode. A guide key 404 is a key for displaying an explanation screen about each mode, a user mode key 405 is a key for entering a user mode screen on which various settings on the apparatus can be made, and an interrupt key 406 is a key for performing an interrupt copy. A start key 407 is a key for stating a copy or scan operation, and a stop key 409 is a key for canceling a job under execution. A power saving key 409 is a key for entering a power saving status. In a case where the power saving key 409 already pressed once is pressed again, the image forming apparatus 101 is returned from the power saving status. A counter check key 410 is a key for displaying, on the touch panel 400, a counted result of the number of sheets outputted by copying or PDL printing. A status LED 411 is an LED indicating that a job execution or an image accumulation in an image memory is in progress. An error LED 412 is an LED indicating that an error state occurs such as a paper jam or a door open state. A main power supply LED 413 is an LED indicating that a main switch is ON. The various keys 401 to 410 may also be software keys formed on the touch panel 400 instead of the hardware keys.

### <Power Statuses of Image Forming Apparatus>

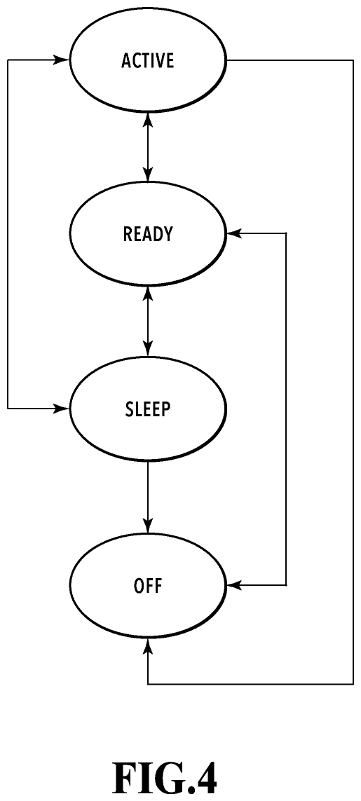

FIG. 4 is a diagram for explaining transitions between multiple power statues in the image forming apparatus 101. The image forming apparatus 101 in the present embodiment has four power statuses, namely, an active status, a ready status, a sleep status, and an off status. The power statuses are defined as follows.

### <<Active Status>>

The active status is a status in which a job is running on the image forming apparatus 101 and the power is supplied to the controller 103 and the operation unit 105 as well as the printer mechanism 104 and/or the scanner mechanism 102 depending on the job. The image forming apparatus 101 transitions to the active status in response to an input of a job in the ready status or the sleep status. In this transition, in the case of a job received in the sleep status from the computer 109 connected via the LAN 108, the power does not have to be supplied to the operation unit 105. The active status is a power status with the highest power consumption among the four power statuses.

### <<Ready Status>>

The ready status is a power status in which the operation unit 105 of the image forming apparatus 101 is turned on and is ready to receive an operation from the user, but no job is running. The image forming apparatus 101 transitions to the ready status in response to an action such as one in which the power switch is turned on in the off status, a sleep return event (such as detection by a human sensor or a touch operation on the touch panel) occurs in the sleep status, or a job execution is completed in the active status. The ready status is a status in which the power is supplied to the controller 103 and the operation unit 105, but no power is supplied to the printer mechanism 104 and the scanner mechanism 102 in principle. In the ready status, the power consumption is lower than in the active status, but is higher than in the sleep status.

### <<Sleep Status>>

The sleep status is a status in which the operation unit 105 of the image forming apparatus 101 is turned off to save a standby power consumption. In the sleep status, the power is supplied only to some parts of the controller 103 and the power-saving key 409 on the operation unit 105 (a touch sensor of the operation unit 105 in a case where the power-saving key is configured as a software button). The image forming apparatus 101 transitions to the sleep status in response to the occurrence of a sleep transition event (such as a depression of the power-saving key 409 or a passage of a predetermined time under the condition that no jobs are executed). In the sleep status, the power consumption is lower than in the ready status, but is higher than in the off status. Here, the sleep status may be further subdivided into some levels depending on how many parts of the controller 103 are supplied with the power.

### <<Off Status>>

The off status is a status in which the image forming apparatus 101 is powered off and the power is supplied only to an electric component to detect a power switch being turned on under the condition that a main power supply is supplied with power through a plug inserted in an outlet. The image forming apparatus 101 transitions to the off status in response to an action such as one in which, in any of the power statuses, namely, the active status, the ready status, and the sleep status, the user turns off the power switch or unplugs the image forming apparatus 101 from the outlet to cut off the power supply to the main power supply. In the off status, the power consumption is lowest among the four power statuses.

In the present embodiment, the image forming apparatus 101 is described as having the above four power statues, but the types of power statuses and transition conditions are not limited to the aforementioned example.

### <Operation Flow of Image Forming Apparatus>

### <<Accumulation of Power-Related Information>>

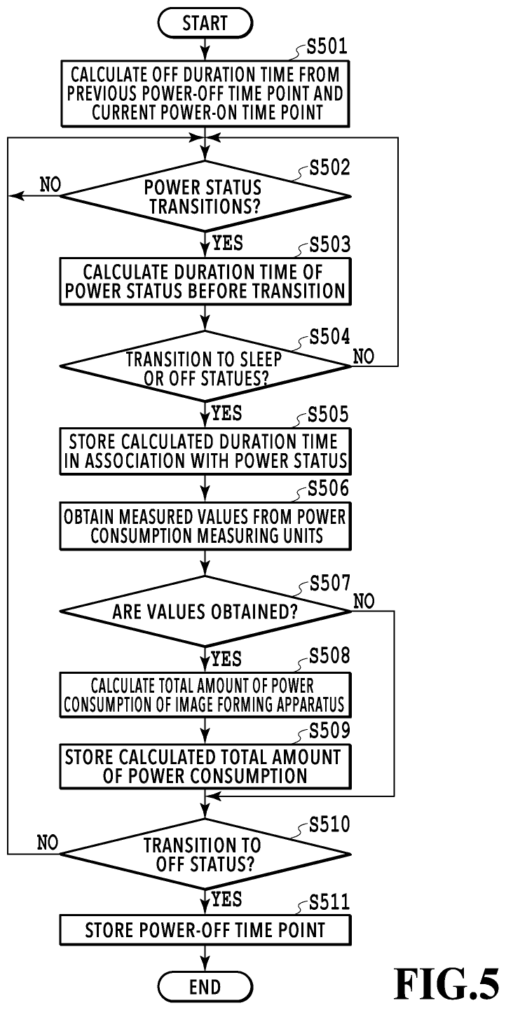

Next, with reference to a flowchart in FIG. 5, description is given of a series of processes for accumulating information on power consumption (power-related information) in the image forming apparatus 101. The series of processes presented in the flowchart in FIG. 5 is performed by the CPU 201 of the controller 103 executing a predetermined program in response to power-on (start of startup) of the image forming apparatus 101. Immediately after the start of the present flow, the image forming apparatus 101 is in the ready status and is kept in the ready status until any of the aforementioned events to serve as triggers for a status transition is detected. In the following description, sign “S” means a step.

In S501, first, a current startup time point (power-on time point) is obtained from the RTC 212 and stored into the memory 203. Next, a shutdown time point (previous power-off time point) stored in S511 to be described later during previous execution of the present flow is read from the HDD 106 and stored into the memory 203. Then, the difference between these two time points is calculated and is stored into the memory 203 as a time period for which the image forming apparatus 101 was powered off (the duration time of the off status).

S502 is a step of monitoring a power status transition. If a power status transition is detected, S503 is executed next. Note that the control for actually transitioning the power status is executed according to another program different from the program that implements the present flow so that the power status transition should be consistent with the present flow (for example, a transition to the off status is performed after execution of S511).

In S503, a current transition start time point is obtained from the RTC 212 and stored in the memory 203. Further, a previous transition start time point stored in the memory 203 is read out. The difference between the current transition start time point and the previous transition start time point is calculated and stored into the memory 203 as a duration time of the power status before the transition.

In S504, which process to execute next is determined depending on the power status after the current transition. In a case where the power status after the current transition is the sleep status or the off status, S505 is executed next, or otherwise, the flow is returned to S502 and the processes are continued.

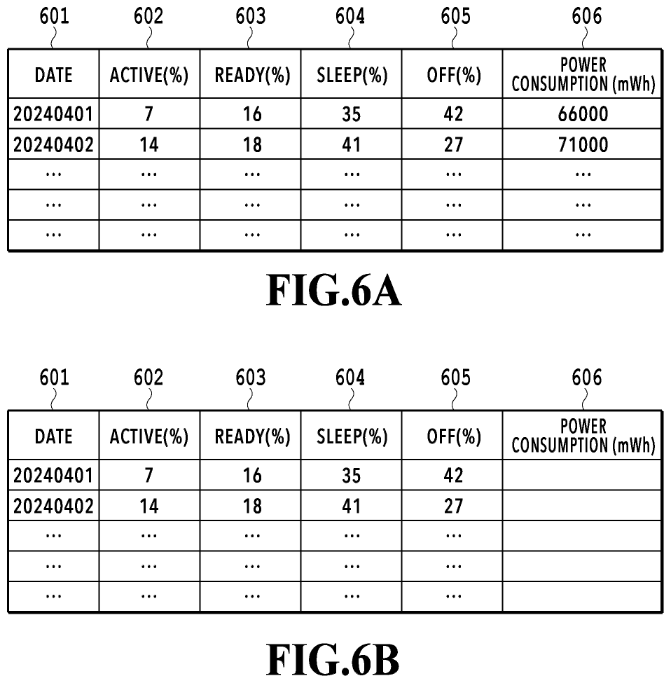

In S505, a process is performed in which, for each of the power statuses, the duration times calculated in S501 and/or S503 and a duration time, if any, already stored are added up to calculate the cumulative duration time for the power status, and the results are stored in the HDD 106 as power-related information. FIG. 6A is an example of the power-related information in a table format composed of a “DATE” column 601, an “ACTIVE” column 602, a “READY” column 603, a “SLEEP” column 604, an “OFF” column 605, and a “POWER CONSUMPTION” column 606. The “DATE” column 601 holds date information. The “ACTIVE” column 602, the “READY” column 603, the “SLEEP” column 604, and the “OFF” column 605 each hold a percentage of the cumulative duration time for the corresponding power statue with the total time for all the power statuses set to 100%. The “POWER CONSUMPTION” column 606 holds an amount of power consumption in the image forming apparatus for the date information, the amount of power consumption calculated in S508 to be described later. The information on the percentage of each of the power statuses and the amount of power consumption is accumulated on a “daily” basis in the table in FIG. 6A, but alternatively may be accumulated on a “weekly” or “monthly” basis. In addition, the percentages of the power statuses are written in the “ACTIVE” column 602, the “READY” column 603, the “SLEEP” column 604, and the “OFF” column 605, respectively. Instead, the cumulative duration times of the power statuses may be written as they are. Alternatively, the information on the cumulative duration times of each of the power statuses may be stored separately in addition to the aforementioned power-related information.

In S506, the CPU 221 of the sub-board 220 is requested via the bus controller 204 to obtain the measured values of the first power measuring unit 308 and the second power measuring unit 309. The CPU 221 thus requested tries to obtain the current measured values (the values of the cumulative amounts of power) of the first power measuring unit 308 and the second power measuring unit 309 of the printer mechanism 104 via the device controller 226. In the case where the CPU 221 obtains the measured values from both the power measuring units 308 and 309, the CPU 221 notifies the CPU 201 of the obtained measured values, and stores the obtained measured values into the HDD 106. In the case where the printer mechanism 104 is not equipped with the first power measuring unit 308 and the second power measuring unit 309 or where the current measured values fail to be obtained for any reason such as a malfunction, the CPU 221 notifies the CPU 201 that the measured values fail to be obtained.

In S507, which process to execute next is determined depending on whether or not the amount of power consumption of the printer mechanism 104 is obtained in S506. If the amount of power consumption is obtained, S508 is executed next. If not, S510 is executed next.

In S508, the amount of power consumed in the image forming apparatus 101 is calculated. Specifically, the amounts of power consumption of the controller 103, the printer mechanism 104, and the scanner mechanism 102 are individually calculated first. Then, the total value of the three amounts of power consumption is obtained as the total amount of power consumption of the image forming apparatus 101. In this process, the amount of power consumption of the controller 103 is obtained by multiplying a power constant for each of the power statuses by its duration time t. Instead, the amount of power consumption of the controller 103 may be obtained by multiplying an average power constant for all the active, ready, and sleep statuses by the total of the duration times of these three power statuses. The amount of power consumption of the scanner mechanism 102 is obtained by multiplying an average amount of power required for one scan (read power constant) by the number of documents scanned. The amount of power consumption of the printer mechanism 104 is calculated based on the measurement results of the first power measuring unit 308 and the second power measuring unit 309. Specifically, first, the previous measured values of both of the first power measuring unit 308 and the second power measuring unit 309 are read from the HDD 106. Then, a difference between each of the read previous measured values and the corresponding one of the currently-obtained measured values is obtained, and then the obtained two differences are added up to obtain the amount of power consumption of the printer mechanism 104. The amount of power consumption of the printer mechanism 104 differs greatly between, for example, during pre-processing (such as chip initialization/temperature adjustment/patch inspection/color tone correction) and during job execution and also varies depending on a content of a job (such as the number of sheets to be printed). Therefore, in order to know the exact amount of power which consumed for a certain period, it is necessary to measure the actual amounts of power consumption by using the measurement instruments. In contrast, in the case of the controller 103 and the scanner mechanism 102, there is no variation as described above, so that the amounts of power consumption close to the actual measured values can be obtained through calculations using the predetermined power constants. The calculation results thus obtained are stored in the memory 203. Note that in the case where the image forming apparatus is the single-function printer having no scan function, the amounts of power consumption of the controller 103 and the printer mechanism 104 are calculated and the total value of the two amounts of power consumption thus calculated is obtained as the total power amount of consumption of the image forming apparatus 101.

In S509, the total amount of power consumption of the image forming apparatus 101 based on the calculation result in S508 is stored in the HDD 106 as the power-related information. Specifically, the value of the amount of power consumption calculated in S508 is entered in the “POWER CONSUMPTION” column 606 in the table in FIG. 6A described above. In the case where the cumulative amounts of power fail to be obtained from the power measuring units in S506, the amount of power consumption of the image forming apparatus is not calculated. In this case, the “POWER CONSUMPTION” column 606 holds no value and remains blank as presented in FIG. 6B.

In S510, which process to execute next is determined depending on whether or not the power status after the current transition is the off status. If the power status after the current transition is the off status, S511 is executed next, or otherwise, the flow is returned to the S502 and the processes are continued.

In S511, the time point is obtained from the RTC 212, and is stored as the power-off time point in the HDD 106. After that, the image forming apparatus 101 is powered off and the present flow is ended.

The above describes the details of the series of processes for accumulating the information on the power consumption in the image forming apparatus 101. Hereinafter, a case where a user performs a series of operations of turning on the power supply, making copies, leaving the image forming apparatus 101 unused for a certain time, and then turning off the power supply is described as an example to explain how the power status transitions from one to another and how the flow in FIG. 5 proceeds in each of the power statuses.

First, upon switching of the power switch from off to on, the power status transitions to the ready status and the duration time of the off status is calculated from the previous power-off time and the current power-on time (S501). After that, in response to a copy instruction issued by the user on the operation unit 105 (Yes in S502), the ready status transitions to the active status and the copy process is executed. During this process, the duration time of the ready status is also calculated (first execution of S503). Then, upon completion of the copy execution, the active status transitions to the ready status again (Yes in S502), and the duration time of the active status is calculated in company with the transition (second execution of S503). Then, upon passage of a certain time in the ready status, the ready status transitions to the sleep status (Yes in S502), and the duration time of the ready status is again calculated (third execution of S503). In addition, each of the duration times calculated so far in S503 is stored in associated with the relevant power status (S505). The measured values are obtained from the first power measuring unit 308 and the second power measuring unit 309 (S506) and the total amount of power consumption of the image forming apparatus is calculated and stored (S508 and S509). After that, the sleep status is kept until the power switch is turned off (No in S510 and No in S502). Then, in the case where the power switch is turned off, the duration time of the sleep status is calculated and stored (fourth execution of S503, Yes in S504, and S505). Then, the measured values are obtained from the first power measuring unit 308 and the second power measuring unit 309 (S506). However, since there is no new print job executed, the same measured values as the previously-obtained values are obtained. Accordingly, even though the amount of power consumption of the image forming apparatus is again calculated and stored, the resultant power consumption is kept unchanged. Then, since the power status transitions to the off status (Yes in S510), the time point of the power-off operation is stored (S511) and the present flow is ended.

In the aforementioned flow in FIG. 5, the processes in S505 to S509 are executed at timing when the power status transitions to the sleep status or the off status. This is for the purpose of minimizing the influence of these processes on the operation of a main function such as copying or printing in the image forming apparatus. However, the start of the processes in S505 to S509 is not limited to the timing of the transition to the sleep status or the off status, and the processes in S505 to S509 may be executed, for example, at regular time intervals.

### <<Presentation of Power-Related Information>>

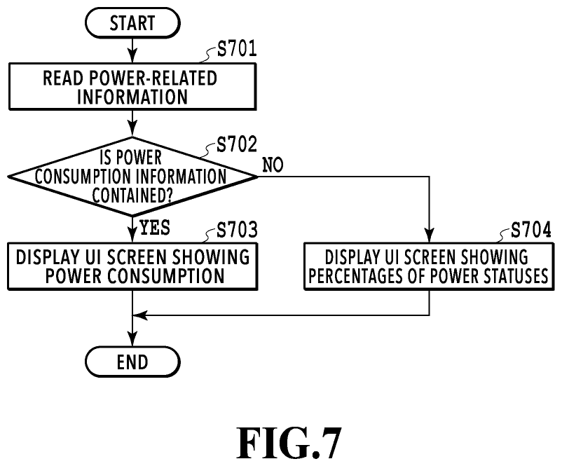

Next, with reference to a flowchart in FIG. 7, description is given of a series of processes for presenting to a user the power-related information accumulated as described above. The series of processes presented in the flowchart in FIG. 7 is performed by the CPU 201 of the controller 103 executing a predetermined program in response to a user's instruction via the operation unit 105 (for example, a depression of a graph display button (not illustrated) on the touch panel 400). In the following description, sign “S” means a step.

In S701, the power-related information stored according to the aforementioned flow in FIG. 5 is read from the HDD 106. Then, in S702, which process to execute next is determined depending on whether or not the power-related information read in S701 contains the information on the amount of power consumption of the image forming apparatus. In the present embodiment, if the “POWER CONSUMPTION” column 606 in the read power-related information table holds some value, S703 is executed next, or if the “POWER CONSUMPTION” column 606 is blank, S704 is executed next.

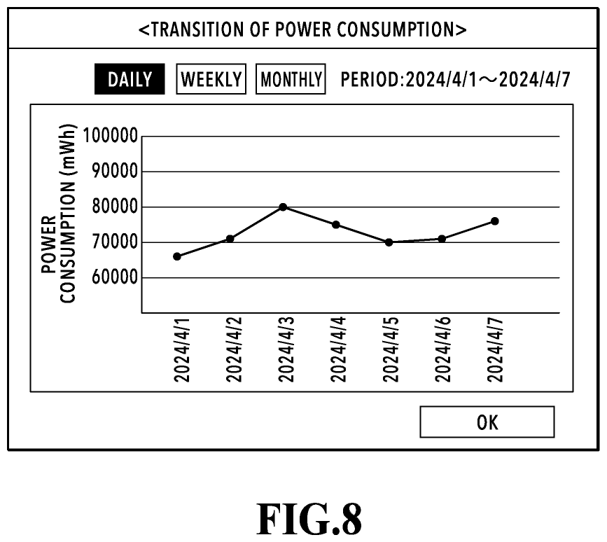

In S703, a UI screen showing a transition of the amount of power consumption of the image forming apparatus 101 is generated and displayed based on the amounts of power consumption of the image forming apparatus contained in the power-related information (the values in the “POWER CONSUMPTION” column 606 in the present embodiment). FIG. 8 is a diagram illustrating an example of the UI screen displayed in this step, the UI screen containing a graph in which the amount of power consumption is plotted at certain time intervals for a certain period. On the UI screen in FIG. 8, a display basis can be selected from “daily”, “weekly”, and “monthly”. On this screen, “daily” is selected and the amount of power consumption is displayed on the daily basis for one week. In this case, the amount of power consumption for two weeks may be displayed. Instead, in the case where “weekly” is selected, the total or average value of the amount of power consumption is displayed on the weekly basis, for example, for the past three months. In the case where “monthly” is selected, the total or average value of the power consumption is displayed on the monthly basis, for example, for the past one year.

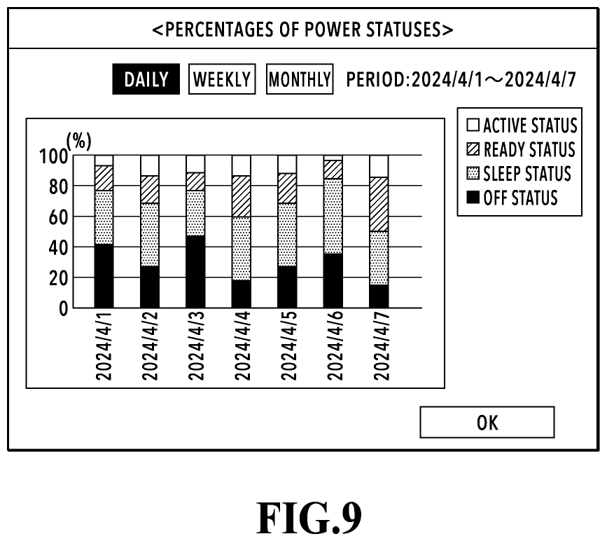

In S704, a UI screen showing the percentages of the respective power statuses in the image forming apparatus 101 is generated and displayed based on the percentages of the power statuses contained in the power-related information (the values in the aforementioned “ACTIVE”, “READY”, “SLEEP”, and “OFF” columns 602 to 605 in the present embodiment). FIG. 9 is a diagram illustrating an example of a UI screen displayed in this step and showing the percentages of the power statuses for a certain period in the image forming apparatus 101. Also on the UI screen in FIG. 9, a display basis can be selected from “daily”, “weekly”, and “monthly” as in the UI screen in FIG. 8. On this screen, “daily” is selected and the percentages of the four power statuses (the active status, the ready status, the sleep status, and the off status) are displayed on the daily basis for one week. In this case, the percentages for two weeks may be displayed. In the case where “weekly” is selected, the average values of the percentages are displayed on the weekly basis, for example, for the past three months. In the case where “monthly” is selected, the average values of the percentages are displayed on the monthly basis, for example, for the past one year.

The above describes the details of the series of processes for presenting the accumulated power-related information to the user. In the foregoing embodiment, the different UI screens are generated and displayed depending on whether or not the power-related information contains the amount of power consumption of the image forming apparatus, but the present disclosure is not limited to this. For example, since the power-related information containing the amount of power consumption of the image forming apparatus also contains the information on the duration times of each of the power statuses, the user may be allowed to select which UI screen is to be displayed, a UI screen showing a transition of the amount of power consumption or a UI screen showing the percentage of each of the power statuses. Instead, in the case where the power-related information contains the amount of power consumption of the image forming apparatus, a UI screen containing both graphs showing a transition of the amount of power consumption and the percentage of each of the power statuses may be displayed.

As described above, according to the present disclosure, it is possible to present, to a user, information concerning power consumption with a different content depending on whether or not the amount of power consumption of the image forming apparatus can be obtained. Thus, it is possible to present an environmentally friendly way of using an image forming apparatus irrespective of whether or not the image forming apparatus is equipped with a power measurement instrument.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-121444, filed Jul. 26, 2024, which is hereby incorporated by reference herein in its entirety.

What is claimed is:

1. A non-transitory computer readable storage medium storing a program for causing a computer to perform a control method of an image forming apparatus including a printing unit, the method comprising the steps of:
in a case where the image forming apparatus includes a measuring unit configured to measure an amount of power consumption of the printing unit, causing the image forming apparatus to execute a first process of displaying an amount of power consumption for a certain period based on a measurement result for the certain period by the measuring unit on a display unit; and
in a case where the image forming apparatus does not include the measuring unit, causing the image forming apparatus to execute a second process of displaying a percentage of each of a plurality of power statuses in the image forming apparatus for the certain period on the display unit.

2. The storage medium according to claim 1, wherein the method further comprises the steps of:
causing the image forming apparatus to further execute a process of storing a cumulative duration time of each of the plurality of power statuses; and
in the case where the image forming apparatus includes the measuring unit, causing the image forming apparatus to execute a process of calculating the amount of power consumption of the image forming apparatus for the certain period by using the measurement result by the measuring unit and storing the amount of power consumption, wherein
the first process includes displaying the amount of power consumption stored for the certain period, and
the second process includes displaying the cumulative duration time of each of the plurality of power statuses stored for the certain period.

3. The storage medium according to claim 1, wherein the plurality of power statuses include two or more power statuses among an active status, a ready status, a sleep status, and an off status.

4. The storage medium according to claim 1, wherein the method further comprises the step of causing the image forming apparatus to execute the second process in place of the first process in the case where the image forming apparatus includes the measuring unit.

5. The storage medium according to claim 4, wherein the method further comprises the step of causing the image forming apparatus to execute a process of receiving a user's selection of which process to execute, the first process or the second process, in the case where the image forming apparatus includes the measuring unit.

6. The storage medium according to claim 1, wherein the method further comprises the step of causing the image forming apparatus to execute a third process in place of the first process in the case where the image forming apparatus includes the measuring unit, the third process including displaying the amount of power consumption for the certain period and the percentages of the plurality of power statuses in the image forming apparatus for the certain period on the display unit.

7. The storage medium according to claim 6, wherein the method further comprises the step of causing the image forming apparatus to execute a process of receiving a user's selection of which process to execute, the first process or the third process, in the case where the image forming apparatus includes the measuring unit.

8. The storage medium according to claim 1, wherein
the image forming apparatus includes a control unit configured to control the printing unit, and
the first process is a process of calculating the amount of power consumption of each of the control unit and the printing unit for the certain period, and displaying a total value of the two amounts of power consumption thus calculated on the display unit.

9. The storage medium according to claim 8, wherein the amount of power consumption of the control unit is obtained by multiplying a power constant of each of the active status, the ready status, and the sleep status by a duration time of the above power status.

10. The storage medium according to claim 8, wherein the amount of power consumption of the control unit is obtained by multiplying an average power constant of the active status, the ready status, and the sleep status by a total of duration times of the active status, the ready status, and the sleep status.

11. The storage medium according to claim 8, wherein
the image forming apparatus further includes a reading unit configured to read a document, and
the first process is a process of calculating the amount of power consumption of each of the control unit, the printing unit, and the reading unit for the certain period, and displaying a total value of the three amounts of power consumption thus calculated on the display unit.

12. The storage medium according to claim 11, wherein the power consumption of the reading unit is obtained by multiplying a predetermined read power constant by the number of read documents.

13. The storage medium according to claim 8, wherein
the measuring unit includes a first measuring unit configured to record a cumulative amount of power consumption required for operations other than a fixing process, and a second measuring unit configured to record a cumulative amount of power consumption required for the fixing process, and
the amount of power consumption of the printing unit is obtained by calculating a difference between a value of the cumulative amount of power at a certain past time point and a value of the cumulative amount of power at a current time point for each of the first measuring unit and the second measuring unit, and adding up the two differences thus obtained.

14. An image forming apparatus comprising:
a printing unit configured to perform a print process;
one or more memories storing instructions; and
one or more processors executing the instructions to:
in a case where the image forming apparatus includes a measuring unit configured to measure an amount of power consumption of the printing unit, execute a first process of displaying the amount of power consumption for a certain period based on a measurement result for the certain period by the measuring unit on a display unit; and
in a case where the image forming apparatus does not include the measuring unit, execute a second process of displaying a percentage of each of a plurality of power statuses in the image forming apparatus for the certain period on the display unit.

15. The image forming apparatus according to claim 14, wherein
the one or more processors execute the instructions to:
execute a process of storing a cumulative duration time of each of the plurality of power statuses, and
in the case where the image forming apparatus includes the measuring unit, execute a process of calculating the amount of power consumption of the image forming apparatus for the certain period by using the measurement result by the measuring unit and storing the amount of power consumption, wherein
the first process includes displaying the amount of power consumption stored for the certain period, and
the second process includes displaying the cumulative duration time of each of the plurality of power statuses stored for the certain period.

16. The image forming apparatus according to claim 14, wherein
the plurality of power statuses include two or more power statuses among an active status, a ready status, a sleep status, and an off status.

17. A control method of an image forming apparatus including a printing unit configured to perform a print process, the method comprising the steps of:
in a case where the image forming apparatus includes a measuring unit configured to measure an amount of power consumption of the printing unit, executing a first process of displaying the amount of power consumption for a certain period based on a measurement result for the certain period by the measuring unit on a display unit; and
in a case where the image forming apparatus does not include the measuring unit, executing a second process of displaying a percentage of each of a plurality of power statuses in the image forming apparatus for the certain period on the display unit.
